(19) United States
(12) Patent Application Publication
(10) Pub. No.: US 2017/0297344 A1
(43) Pub. Date: Oct. 19, 2017

(54) INKJET PRINTING APPARATUS AND METHOD OF DETECTING INK AMOUNT

(71) Applicant: CANON KABUSHIKI KAISHA, Tokyo (JP)

(72) Inventors: Tsuyoshi Ibe, Yokohama-shi (JP); Masaya Uetsuki, Yokohama-shi (JP); Toshimitsu Danzuka, Tokyo (JP); Kazuo Suzuki, Yokohama-shi (JP); Yoshinori Nakagawa, Kawasaki-shi (JP); Masataka Kato, Yokohama-shi (JP); Shin Genta, Yokohama-shi (JP); Tomoki Yamamuro, Kawasaki-shi (JP)

(21) Appl. No.: 15/469,831

(22) Filed: Mar. 27, 2017

(30) Foreign Application Priority Data
Apr. 13, 2016 (JP) 2016-080473

(51) Int. Cl. B41J 2/175

(52) U.S. Cl. CPC B41J 2/17566

(57) ABSTRACT

An inkjet printing apparatus capable of detecting an ink amount in an attachable inktank at a multi-level with a simple arrangement has the following arrangement. That is, the printing apparatus includes a printhead which prints an image by discharging ink, an inktank which contains the ink supplied to the printhead, a reservoir capable of temporarily containing the ink supplied from the inktank, and a detection unit which performs a detection operation of detecting whether the ink amount in the inktank is more than a predetermined amount. Then, the detection unit performs the detection operation in a state in which the reservoir contains the ink supplied from the inktank.

### BACKGROUND OF THE INVENTION

### Field of the Invention

The present invention relates to a printing apparatus and a method of detecting an ink amount, and particularly to, for example, an inkjet printing apparatus that supplies ink from an attachable inktank which contains the ink to a printhead and a method of detecting the ink amount in that inktank.

### Description of the Related Art

Recently, an inkjet printing apparatus (to be referred to as a printing apparatus) is used to print on a print medium of a large size such as an A1 or A0 print sheet. It is in wide printing application from a line image of an achromatic color to a photographic image. In particular, when an image of a relatively high duty such as a photographic image is printed, a large amount of ink is consumed to print one image. Therefore, an inktank is required to increase in capacity. In order to respond to such a demand, there is a printing apparatus configured to connect a printhead mounted on a carriage or the like to move and a large-capacity inktank mounted on an apparatus main body via a tube or the like, and to supply ink from the inktank.

If the large amount of ink is consumed to print on one print medium, the inktank is replaced at a high frequency. An increase in the frequency of replacing the inktank may lead to not only an increase in loss of time associated with an interruption of a printing operation but also a deterioration in image quality such as a color unevenness caused by a time difference arising from the interruption of the printing operation.

Therefore, in order to avoid inktank replacement accompanying the interruption of the printing operation, sensing an ink residual amount in the inktank accurately and, in particular, an improvement in sensing accuracy in a state in which the ink residual amount in the inktank approaching its replacement timing is little are required. Japanese Patent Laid-Open No. 2002-234182 proposes a method of sensing an ink residual amount in an inktank by providing a pair of electrodes in the inktank to send an electric current and measuring an increase in electric current value if ink becomes less than the height of each electrode. According to Japanese Patent Laid-Open No. 2002-234182, it is possible, by providing the pair of electrodes at the bottom of the inktank, to accurately sense a small predetermined residual amount in the inktank approaching its replacement timing.

In the method proposed by Japanese Patent Laid-Open No. 2002-234182, an arrangement is adopted in which the pair of electrodes is provided at the bottom of the inktank, making it possible to detect that the ink residual amount becomes small, and an ink height becomes lower than an electrode height. In this method, however, a detectable ink height is unique while the sensing accuracy is high, making it impossible to detect a change in residual amount while consuming the ink. In order to solve this problem, it is considered that a plurality of pairs of electrodes are provided in the inktank to obtain a plurality of detectable heights. In this case, however, another problem arises in that an arrangement for detecting the ink residual amount becomes complicated and upsized, leading to an increase in cost.

### SUMMARY OF THE INVENTION

Accordingly, the present invention is conceived as a response to the above-described disadvantages of the conventional art.

For example, an inkjet printing apparatus and a method of detecting an ink amount according to this invention are capable of detecting the ink amount at a plurality of levels with a simple arrangement.

According to one aspect of the present invention, there is provided an inkjet printing apparatus comprising: a printhead configured to print an image by discharging ink; an inktank configured to contain the ink supplied to the printhead; a reservoir capable of temporarily containing the ink supplied from the inktank; a detection unit configured to perform a detection operation of detecting whether an ink amount in the inktank is more than a predetermined amount; and a control unit configured to cause the detection unit to perform the detection operation in a first state in which the reservoir contains the ink supplied from the inktank.

According to another aspect of the present invention, there is provided a method of detecting an ink amount in an inkjet printing apparatus which includes a printhead configured to print an image by discharging ink, and an inktank configured to contain the ink supplied to the printhead, the method comprising: performing a detection operation of detecting whether the ink amount in the inktank is more than a predetermined amount in a first state in which a reservoir capable of temporarily containing the ink supplied from the inktank contains the ink supplied from the inktank.

The invention is particularly advantageous since the ink amount can be detected accurately at a multi-level with a simpler arrangement.

Further features of the present invention will become apparent from the following description of exemplary embodiments (with reference to the attached drawings).

### BRIEF DESCRIPTION OF THE DRAWINGS

FIG. 1 is a partially cutaway perspective view showing the schematic arrangement of an inkjet printing apparatus according to an exemplary embodiment of the present invention.

FIG. 2 is a block diagram showing the control arrangement of a printing apparatus shown in FIG. 1.

FIG. 3 is a view showing the arrangement of an ink supply subsystem according to the first embodiment.

FIGS. 4A and 4B are flowcharts showing ink residual amount detection processing during image forming in a printing apparatus which includes the ink supply subsystem having the arrangement shown in FIG. 3.

FIG. 5 is a view showing a situation in which ink in an inktank is consumed and set in a near end state.

FIGS. 6A and 6B are views each showing the relationship between a change in liquid surface level in the inktank and a volume change of a liquid surface control member in the ink supply subsystem.

FIGS. 7A and 7B are flowcharts showing multi-level ink residual amount detection processing before the near end.

FIGS. 8A and 8B are views showing the arrangement of an ink supply subsystem according to the second embodiment.

FIGS. 9A and 9B are flowcharts showing ink residual amount detection processing during image forming in a printing apparatus which includes the ink supply subsystem having the arrangement shown in FIGS. 8A and 8B.

FIGS. 10A and 10B are views showing states of volume changes of a liquid surface control member in the ink supply subsystem shown in FIGS. 8A and 8B.

### DESCRIPTION OF THE EMBODIMENTS

Exemplary embodiments of the present invention will now be described in detail in accordance with the accompanying drawings. Note that the same reference numerals denote the same parts already described, and a description thereof will not be repeated.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium (or sheet)” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

Further, a “nozzle” generically means an ink orifice or a liquid channel communicating with it, and an element for generating energy used to discharge ink, unless otherwise specified.

An element substrate (head substrate) for a printhead to be used below indicates not a mere base made of silicon semiconductor but a component provided with elements, wirings, and the like.

“On the substrate” not only simply indicates above the element substrate but also indicates the surface of the element substrate and the inner side of the element substrate near the surface. In the present invention, “built-in” is a term not indicating simply arranging separate elements on the substrate surface as separate members but indicating integrally forming and manufacturing the respective elements on the element substrate in, for example, a semiconductor circuit manufacturing process.

An inkjet printing apparatus according to an embodiment will now be described. This printing apparatus is an apparatus which uses a continuous sheet (print medium) of a B0 or A0 size wound into a roll and performs large print of printing an image on that sheet. Note that a cut sheet may be used for the print medium to be used.

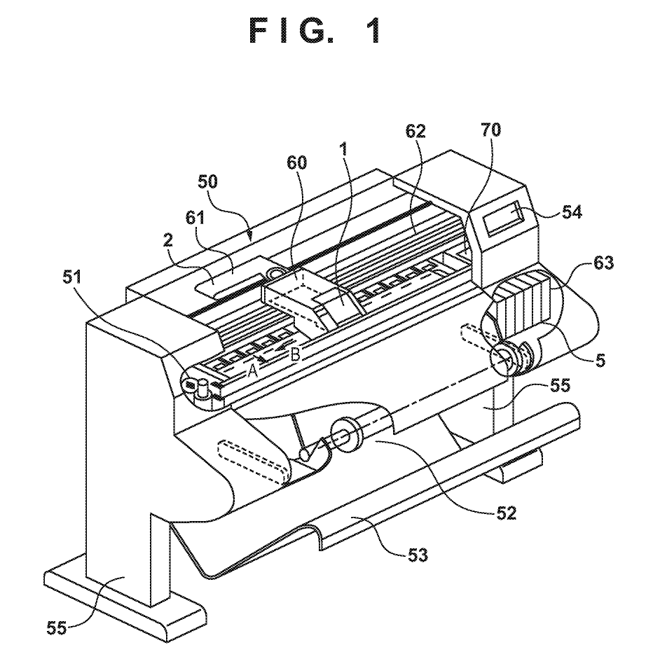

FIG. 1 is a partially cutaway perspective view showing the schematic arrangement of an inkjet printing apparatus according to an exemplary embodiment of the present invention.

As shown in FIG. 1, the inkjet printing apparatus (to be referred to as a printing apparatus) 50 is fixed astride the upper end portions of two legs 55. A carriage 60 mounts a printhead 1. The print medium set in a roll holder unit 52 is fed to a printing position at the time of printing, and ink droplets are discharged from respective nozzles of the printhead 1 while a carriage motor (not shown) and a belt 62 reciprocally move the carriage 60 in a direction (main-scanning direction) indicated by an arrow B. When the carriage 60 moves to one end of the print medium, a conveyance roller 51 conveys the print medium by a predetermined amount in a direction (sub-scanning direction) indicated by an arrow A. An image is formed on the entire print medium by repeating a printing operation and a conveyance operation alternately as described above. After the image is formed, the print medium is cut by a cutter (not shown), and the cut print medium is stacked in a stacker 53.

In an ink supply unit 63, inktanks 5 divided for respective ink colors such as black, cyan, magenta, and yellow are provided attachably to an apparatus main body. Each inktank 5 is connected to a supply tube 2. A tube guide 61 holds the supply tube 2 so as not to be in disorder when the carriage 60 moves reciprocally.

A plurality of orifice arrays (nozzle arrays) (not shown) arrayed in a direction crossing the main-scanning direction are provided on the discharge surface of the printhead 1 facing the print medium. Each inktank 5 is connected to the supply tube 2 (ink channel) for each orifice array.

A recovery unit 70 is further provided at a position outside a region through which the print medium passes in the main-scanning direction and facing an orifice surface. The recovery unit 70 executes, as needed, a wiping operation of cleaning ink sticking to the orifice surface of the printhead 1, or a suction operation of forcibly sucking the ink or a bubble in an orifice of the printhead.

An operation panel 54 is provided on the right side of the printing apparatus 50. The operation panel 54 can prompt a user to replace each inktank 5 by display a warning message when ink in the inktank 5 runs out.

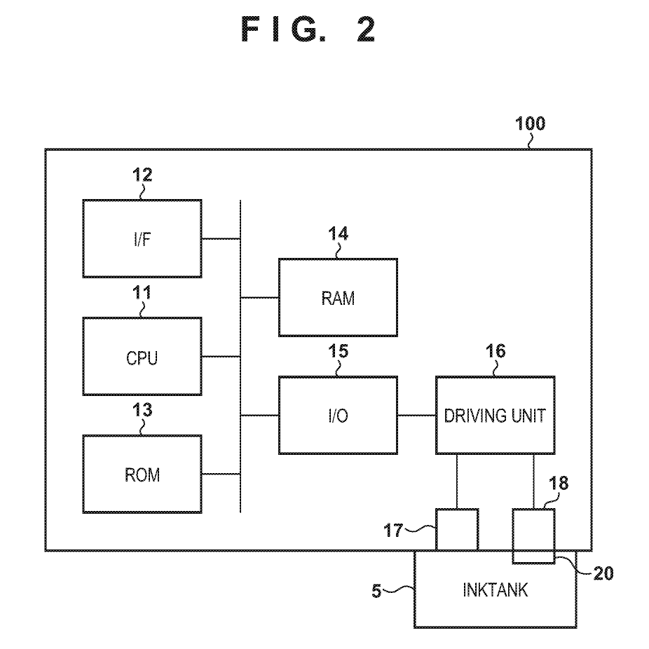

FIG. 2 is a block diagram showing the control arrangement of the printing apparatus shown in FIG. 1.

As shown in FIG. 2, the printing apparatus 50 includes a CPU 11 which controls the overall apparatus, a user interface 12 that includes an operation panel which displays information or keys operated by the user, and a ROM 13 which stores control software. The printing apparatus 50 further includes a RAM 14 temporarily used when operating the control software, an I/O port 15 which inputs/outputs a control signal, a sensor signal, a print signal, or the like, a driving unit 16 as mentioned in FIG. 1, and an ink residual amount sensor 17 which detects the residual amount in each inktank.

The ink residual amount sensor 17 monitors a resistance value between a first hollow tube 8 and a second hollow tube 9 when a minute electric current is sent between them, and detects that an ink amount in each inktank becomes less than a predetermined amount, and ink nearly runs out (near end). An inktank attachment sensor 18 determines attachment/detachment of each inktank 5 by a read value from an EEPROM 20 included in the inktanks 5. The contents of the EEPROM 20 are rewritten via the inktank attachment sensor 18.

Detection of the ink residual amount in each inktank executed by the printing apparatus 50 having the above arrangement according to some embodiments will now be described.

### First Embodiment

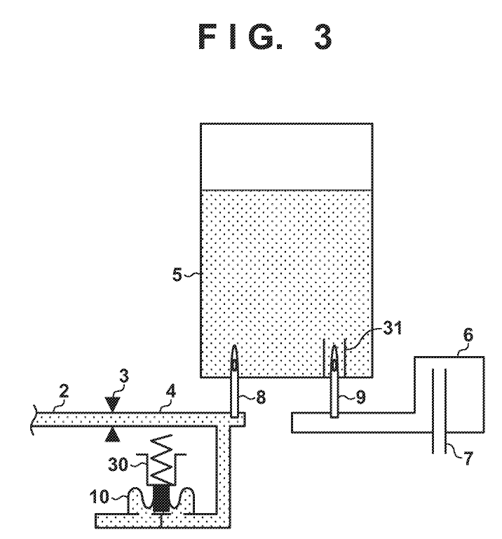

FIG. 3 is a view showing the arrangement of the ink supply subsystem of the printing apparatus shown in FIG. 1. As described above, the printing apparatus 50 uses inks of a plurality of colors. However, the arrangements of ink supply subsystems are identical throughout a plurality of inks, and thus a supply subsystem of one colored ink will be described here.

As shown in FIG. 3, an inktank 5 at a constant volume attachable to the printing apparatus includes two joint portions at the bottom. Those joint portions are coupled to a first hollow tube 8 and a second hollow tube 9 of an apparatus main body. The first hollow tube 8 and the second hollow tube 9 are made of hollow metal needles. Vertical walls 31 are formed from the bottom of the inktank around the second hollow tube 9 in the inktank 5. With this structure, if the height of a contained ink residual amount is lower than the vertical walls 31 when a minute electric current (constant electric current) is sent between the first hollow tube and the second hollow tube, the electric current via the ink is avoided, increasing a resistance value between two hollow tubes. This appears as an increase in a voltage value to be measured. This makes it possible to detect that the ink in the inktank 5 nearly runs out (near end).

The second hollow tube 9 communicates with an air communication section 6. The inktank 5 communicates with air via an air communication path 7 in the air communication section 6. The bottom of the inktank 5 and the top surface of a connection path 4 for supplying the ink to a printhead communicate with each other by the first hollow tube 8. The connection path 4 and a supply tube 2 communicate with each other via opening/closing valves 3. In the connection path 4, there is a channel branched out from the end portion on a side opposite to a side connected to the supply tube 2, and a liquid surface control member 10 made of a flexible member changeable in volume is provided on that channel. The liquid surface control member 10 acts as a container which temporarily contains the ink. However, its containment amount changes by a volume change.

The liquid surface control member 10 is biased in a closing direction when a spring 30 biases a lever and is released when a cam (not shown) pushes up the lever against the biasing force of the spring. That cam is configured such that its position can be detected by a photosensor and undergoes rotation control via a gear (not shown) by a driving force from a DC motor (driving source). Consequently, the liquid surface control member 10 changes its volume in synchronization with stretch and compression of the spring 30.

The levers of a plurality of inktanks are coupled to each other, and one motor simultaneously performs opening/closing control of the liquid surface control members of the plurality of inktanks. Consequently, the ink in each inktank is moved by the volume change in the liquid surface control member 10, stirring the ink in the inktank.

The printing apparatus of this embodiment is configured to attach the inktank to the joint portions of the apparatus main body as described above and can detect an ink liquid surface by using the first hollow tube 8 and the second hollow tube 9 coupled to the joint portions. This makes it possible, by detecting that a residual amount in the inktank is set to a near end state by consuming the ink in a printing operation or the like, to prompt a user to prepare an inktank for replacement before the ink in the inktank runs out completely.

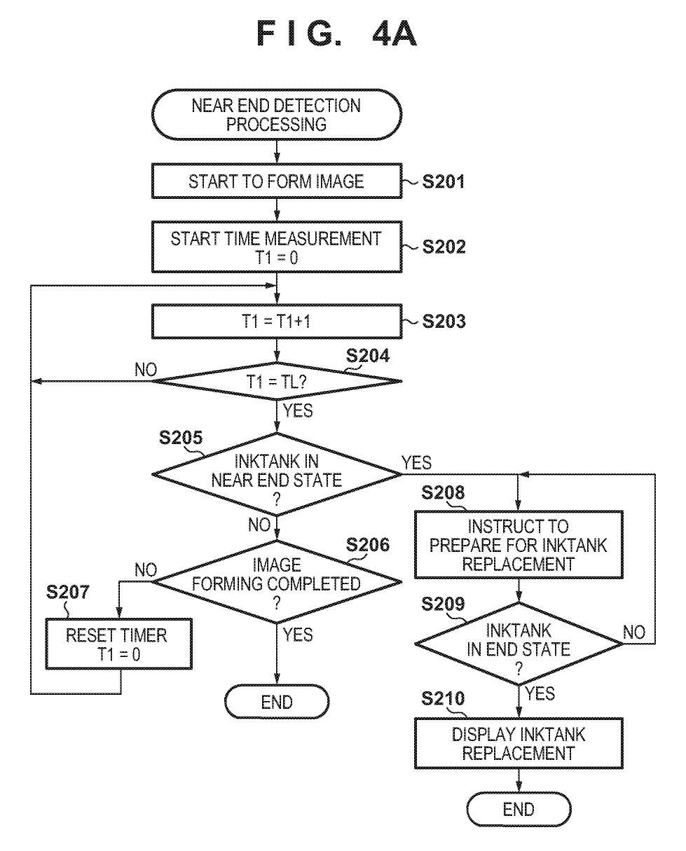

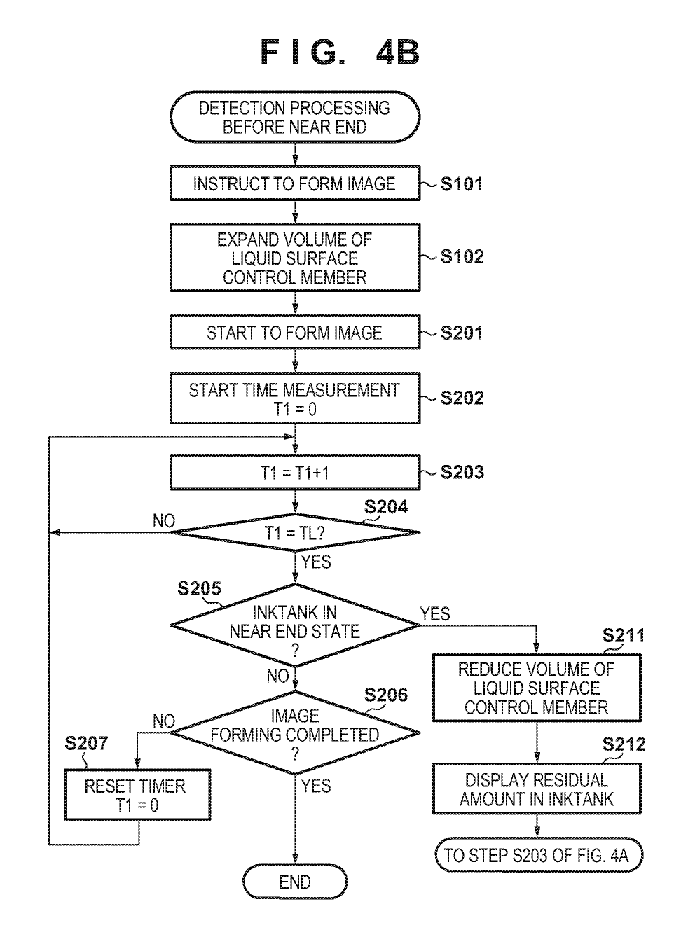

FIGS. 4A and 4B are flowcharts showing ink residual amount detection processing during image forming in the printing apparatus which includes the ink supply subsystem having the arrangement shown in FIG. 3.

FIG. 4A is a flowchart showing near end detection processing. FIG. 4B is a flowchart showing a process of detecting a state before the near end.

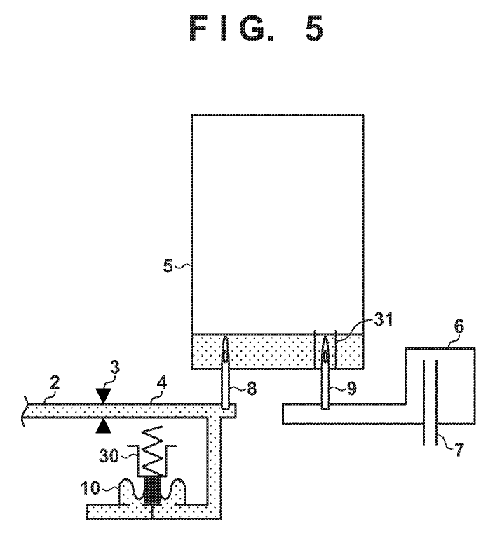

FIG. 5 is a view showing a situation in which the ink in the inktank 5 is consumed and set in the near end state.

As described already, if an ink amount is decreased by consuming the ink in the inktank 5, and the liquid surface becomes lower than the vertical walls 31 around the hollow tube 9, it becomes difficult to send the electric current between the first hollow tube 8 and the second hollow tube 9. As a result, the voltage value increases, making it possible to detect the near end of the ink in the inktank 5. The near end detection processing in such a state will be described with reference to the flowchart of FIG. 4A.

Near End Detection Processing (FIG. 4A)

When an image forming instruction is sent from a host apparatus (not shown) such as a PC to a printing apparatus 50, in step S201, image forming on a print medium is started by discharging ink from a printhead 1 while moving a carriage. At this time, measurement of an elapsed time is further started in step S202. Then, in step S203, a value of a counter (T1) which stores the elapsed time per second is counted up (+1). Furthermore, it is checked in step S204 whether the elapsed time reaches a predetermined time TL (TL=3), and the processes in steps S203 and S204 are repeated until the elapsed time reaches the predetermined time.

If it is determined here that the elapsed time reaches the predetermined time (T1=TL), the process advances to step S205 in which it is checked whether the ink in the inktank is in the near end state. This detection principle is as described above. If it is determined here that the ink in the inktank does not reach the near end, the process advances to step S206 in which it is further confirmed whether an image forming operation is completed. If it is determined here that the image forming operation is continued, the process advances to step S207 in which the elapsed time of the counter (T1) is reset to zero (0), and the process returns to step S203. In contrast, if it is determined that the image forming operation is completed, the near end detection processing ends.

If it is determined in step S205 that the ink in the inktank is in the near end state, the process advances to step S208 in which the user is notified that the residual amount in the inktank is little through an operation panel 54 and prompted to prepare for inktank replacement. Subsequently, in step S209, an ink consumption amount (CSMP) is calculated by counting the number of ink droplets discharged from the printhead after the near end is detected. In addition, the ink consumption amount is compared with an acceptable ink consumption amount (to be referred to as an end amount (END) hereinafter) after the near end stored in a memory of the printing apparatus in advance. If the ink consumption amount falls within the end amount (CSMP<END) here, it is determined that the ink tank is not in the end state and the image forming operation is allowed, and the process returns to step S208. If the ink consumption amount is equal to or larger than the end amount (CSMP≧END), it is determined that the ink in the inktank runs out, and the process advances to step S210.

In step S210, the image forming operation is stopped, and a message to prompt inktank replacement is displayed on the operation panel 54. It is possible, by making a determination of whether the near end is reached at a predetermined timing (every three seconds here) during the image forming operation as described above, to notify the user of a preparation for inktank replacement at an appropriate timing.

The process of detecting the state before the ink in the inktank is set in the near end state will now be described with reference to the flowchart of FIG. 4B. Note that in the flowchart of FIG. 4B, the same processing steps as shown in FIG. 4A are denoted by the same step reference numbers, and an explanation thereof will be omitted.

Detection Processing Before Near End (FIG. 4B)

This processing is implemented by combining a volume change operation of the liquid surface control member 10, and a residual amount detection operation by electrodes by detecting the ink liquid surface in the inktank using the first hollow tube 8 and the second hollow tube 9.

First, when an image forming instruction is sent from the host apparatus to the printing apparatus in step S101, the volume of the liquid surface control member 10 is expanded in step S102, lowering the ink liquid surface in the inktank 5 by an amount corresponding to the volume of the liquid surface control member 10.

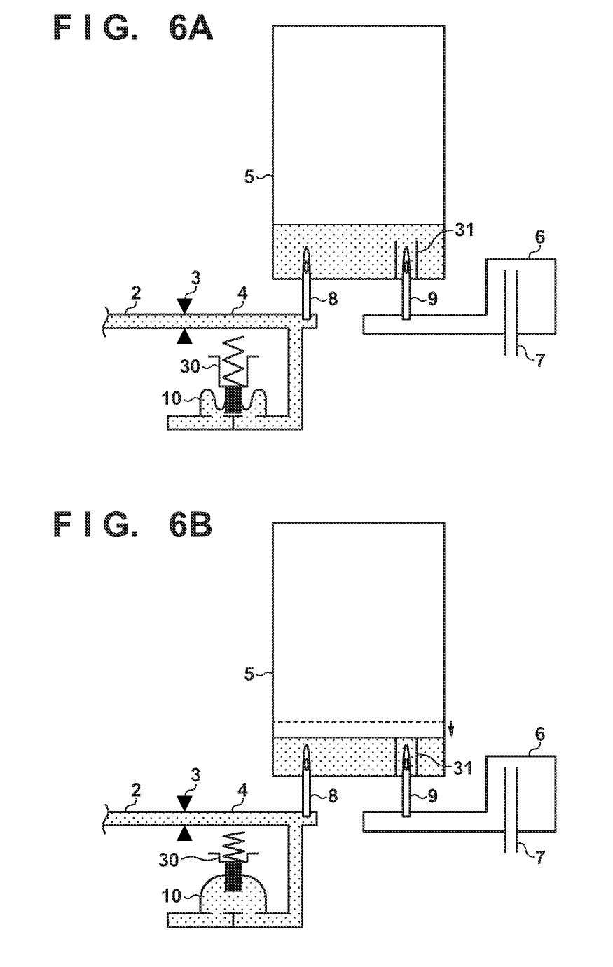

FIGS. 6A and 6B are views each showing the relationship between a change in liquid surface level in the inktank and a volume change of the liquid surface control member in the ink supply subsystem.

FIG. 6A shows the ink liquid surface in the inktank 5 in a state in which the volume of the liquid surface control member 10 is reduced. FIG. 6B shows the liquid surface in the inktank 5 in a state in which the volume of the liquid surface control member 10 is expanded. Note that ink residual amounts in the inktanks 5 in FIGS. 6A and 6B are the same. As described above, the volume of the liquid surface control member 10 is expanded, moving the ink of that volume change amount from the inktank 5 to the liquid surface control member 10. As a result, the ink liquid surface in the inktank falls from a dotted line indicating a state in FIG. 6A to a solid line as shown in FIG. 6B.

Subsequently, as described with reference to FIG. 4A, image forming is started based on the received image forming instruction, and steps S201 to S207 are performed. Note that in this processing, if it is determined in step S205 that the ink in the inktank 5 is in the near end state, the process advances to step S211 in which the volume of the liquid surface control member 10 is reduced. Consequently, the ink returns to the inktank 5 by a volume reduction amount of the liquid surface control member 10 as shown in FIG. 6A. Thus, the residual amount in the inktank becomes an amount (NEND+V) obtained by adding a volume reduction amount (V) of the liquid surface control member 10 to a near end capacity (NEND). Therefore, in step S212, a message indicating that the residual amount in the inktank is little, and the above-described ink residual amount (NEND+V) is set is displayed through the operation panel 54, notifying the user that the near end is near.

Note that the ink residual amount at this point in time is approaching the near end, and thus the process moves to step S203 of FIG. 4A to continue the image forming operation and subsequently, residual amount detection processing by the electrodes is executed.

It is possible, by performing processing obtained by combining the residual amount detection operation by the electrodes and the volume change operation of the liquid surface control member 10 as described above, to detect an amount obtained by adding the volume change amount of the liquid surface control member 10 to a near end amount from a state in which the ink residual amount in the inktank cannot be grasped until it is set to the near end state. For example, if the near end amount is 5 cc (known), and the volume change amount of the liquid surface control member 10 is 5 cc (known), the ink residual amount in the inktank can be displayed to the user at two levels of 5 cc and 10 cc. This makes it possible to notify the user of the preparation for inktank replacement or the like at a timing sufficiently in advance.

It is also possible, by adopting an arrangement in which the volume change amount of the liquid surface control member 10 is controlled at a plurality of levels, to detect the ink residual amount until near end detection at a multi-level. For example, if the volume change amount of the liquid surface control member 10 is controlled every 1 cc when the near end amount is 5 cc, and the volume change amount is 5 cc, it becomes possible to detect the residual amount in the inktank every 1 cc from 10 cc to 5 cc.

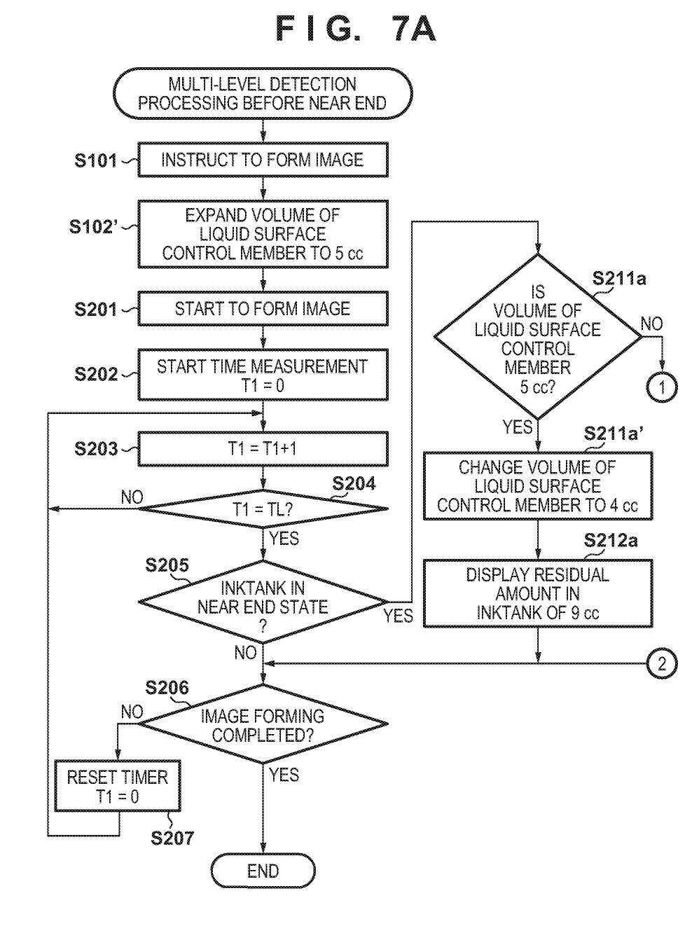

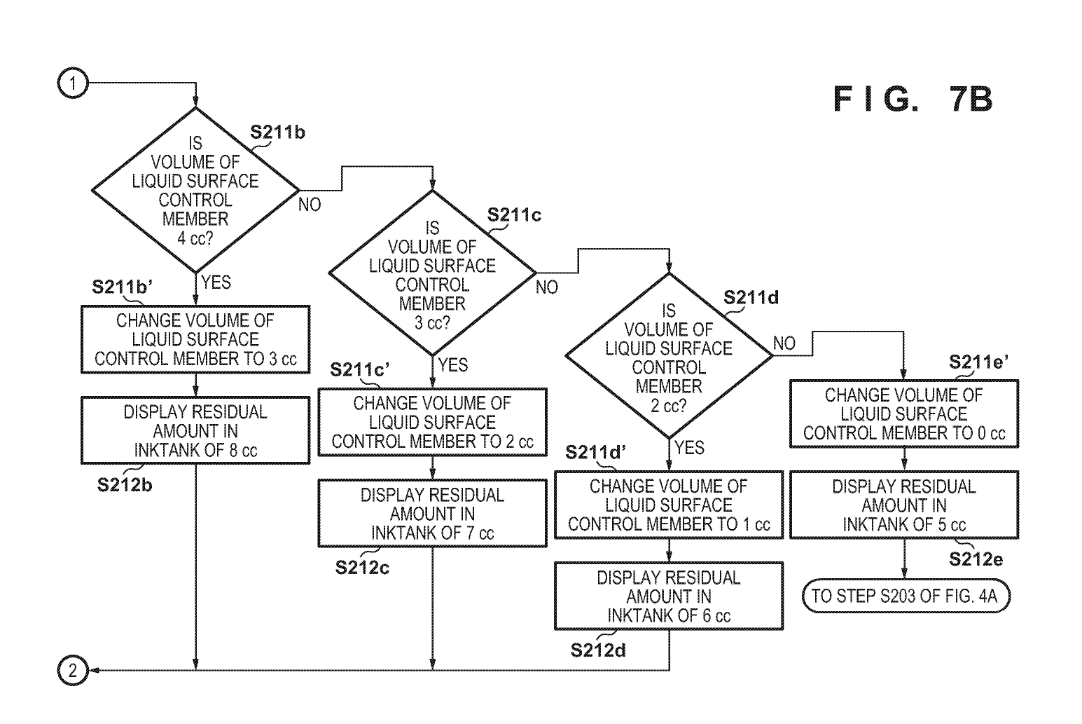

Multi-level ink residual amount detection before the near end implemented by combining multi-level control of the volume change of the liquid surface control member 10 and near end detection will now be described with reference to flowcharts of FIGS. 7A and 7B. Note that in the flowcharts of FIGS. 7A and 7B, the same processing steps that have already been described with reference to FIGS. 4A and 4B are denoted by the same step processing numbers, and an explanation thereof will be omitted.

Multi-Level Ink Residual Amount Detection Processing Before Near End (FIGS. 7A and 7B)

First, as described in FIG. 4B, when the image forming instruction from the host apparatus is received in step S101, the volume of the liquid surface control member 10 is expanded to 5 cc in step S102′, lowering the ink liquid surface in the inktank by an amount corresponding to the expanded volume amount of the liquid surface control member 10. Subsequently, as described in FIG. 4A, the image forming operation is started based on the received image forming instruction, and steps S201 to S207 are performed. Note that in this processing, if it is determined in step S205 that the ink in the inktank 5 is in the near end state, the process advances to step S211a to check the volume of the liquid surface control member 10.

More specifically, it is checked in step S211a whether the volume of the liquid surface control member 10 is 5 cc. If it is determined that the volume is 5 cc, the process advances to step S211a′ in which the volume of the liquid surface control member 10 is reduced to 4 cc. At this time, the ink of 1 cc corresponding to the volume change amount of the liquid surface control member returns to the inktank 5, and thus the ink residual amount in the inktank 5 becomes an amount obtained by adding 1 cc to the near end amount. Then, the residual amount in the inktank is displayed as 9 cc on the operation panel 54 in step S212a. Subsequently, the process advances to step S206.

If it is determined in step S211a that the volume of the liquid surface control member 10 is not 5 cc, the process advances to step S211b. Then, it is checked whether the volume of the liquid surface control member 10 is 4 cc. If it is determined that the volume is 4 cc, the process advances to step S211b′ in which the volume of the liquid surface control member 10 is reduced to 3 cc. At this time, the ink of 1 cc corresponding to the volume change amount of the liquid surface control member returns to the inktank 5, and thus the ink residual amount in the inktank 5 becomes an amount obtained by adding 1 cc to the near end amount. Then, the residual amount in the inktank is displayed as 8 cc on the operation panel 54 in step S212b. Subsequently, the process advances to step S206.

If it is determined in step S211b that the volume of the liquid surface control member 10 is not 4 cc, the process advances to step S211c. Then, it is checked whether the volume of the liquid surface control member 10 is 3 cc. If it is determined that the volume is 3 cc, the process advances to step S211c′ in which the volume of the liquid surface control member 10 is reduced to 2 cc. At this time, the ink of 1 cc corresponding to the volume change amount of the liquid surface control member returns to the inktank 5, and thus the ink residual amount in the inktank 5 becomes an amount obtained by adding 1 cc to the near end amount. Then, the residual amount in the inktank is displayed as 7 cc on the operation panel 54 in step S212c. Subsequently, the process advances to step S206.

If it is determined in step S211c that the volume of the liquid surface control member 10 is not 3 cc, the process advances to step S211d. Then, it is checked whether the volume of the liquid surface control member 10 is 2 cc. If it is determined that the volume is 2 cc, the process advances to step S211d′ in which the volume of the liquid surface control member 10 is reduced to 1 cc. At this time, the ink of 1 cc corresponding to the volume change amount of the liquid surface control member returns to the inktank 5, and thus the ink residual amount in the inktank 5 becomes an amount obtained by adding 1 cc to the near end amount. Then, the residual amount in the inktank is displayed as 6 cc on the operation panel 54 in step S212d. Subsequently, the process advances to step S206.

If it is further determined in step S211d that the volume of the liquid surface control member 10 is not 2 cc, the process advances to step S211e′ in which the volume of the liquid surface control member 10 is reduced to 0 cc, that is, maximizing the reduction limit. At this time, the ink of 1 cc corresponding to the volume change amount of the liquid surface control member returns to the inktank 5, and thus the ink residual amount in the inktank 5 becomes an amount obtained by adding 1 cc to the near end amount. Then, the residual amount in the inktank is displayed as 5 cc on the operation panel 54 in step S212e. At this point in time, the ink residual amount in the inktank really reaches a state immediately before the near end amount. Therefore, subsequently, the process advances to step S203 of FIG. 4A to shift to the near end detection processing.

As described above, it becomes possible, by performing the process shown in FIGS. 7A and 7B, to notify the user of a consumption history from 9 cc to 5 cc of the residual amount in the inktank every 1 cc through the operation panel or the like. Note that the volume change of the liquid surface control member is implemented by stretching and compressing the spring 30 by performing rotation control of the cam via the gear (not shown) with the driving force from the DC motor, as described above.

Therefore, according to the embodiment described above, it is possible, by providing an arrangement in which the ink in the inktank is temporarily saved on an appropriate amount basis at a plurality of levels, to accurately sense the ink residual amount at the plurality of levels without providing a plurality of electrodes in the inktank.

### Second Embodiment

In this embodiment, an example of ink residual amount detection when an ink supply subsystem different from the ink supply subsystem shown in FIG. 3 that has been described in the first embodiment is used will be described.

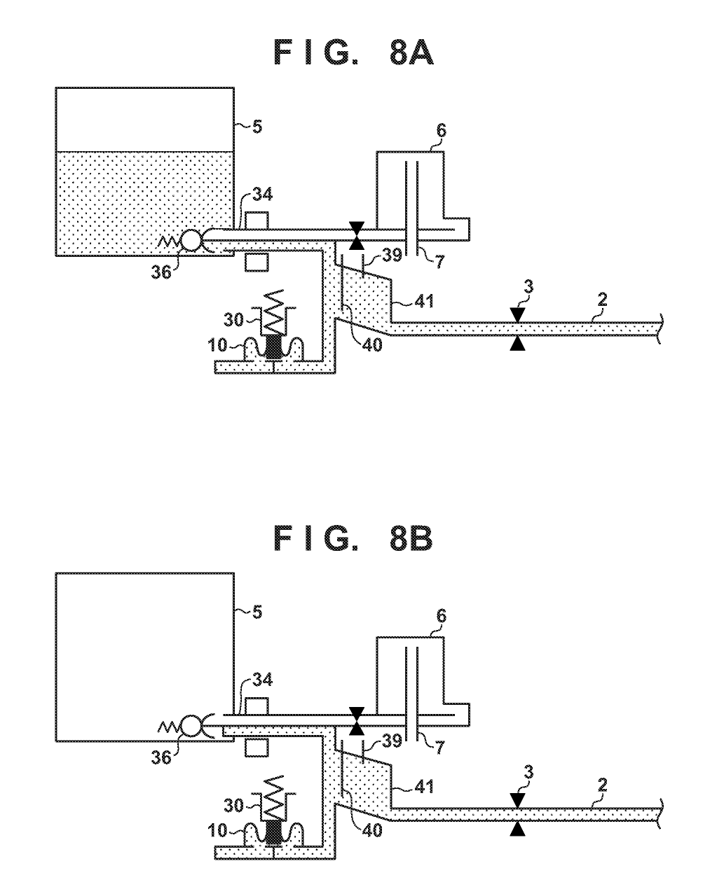

FIGS. 8A and 8B are views each showing the arrangement of the ink supply subsystem according to the second embodiment. As described above, the printing apparatus 50 uses inks of a plurality of colors. However, the arrangements of ink supply subsystems are identical throughout a plurality of inks, and thus a supply subsystem of one color ink will be described here. Further, the same constituent elements as those described already in the first embodiment with reference to FIG. 3 are denoted by the same reference numerals, and an explanation thereof will be omitted. This embodiment is characterized by an arrangement in that a subtank is provided between an inktank 5 and a printhead 1, and ink is supplied to the printhead via the subtank.

As shown in FIG. 8A, the inktank 5 with a non-changing volume attachable to an apparatus includes, inside thereof, a joint portion 36 which is made of a spherical member biased in a closing direction by a spring, and the joint portion 36 is coupled to a hollow tube 34 of the apparatus. With this arrangement, when the inktank 5 is not connected to the apparatus, the joint portion 36 biased in the closing direction prevents ink from leaking outside the inktank.

The inside of the hollow tube 34 coupled to the joint portion 36 is divided into two branches. One branch is connected to an air communication section 6, and the inktank 5 communicates with air via an air communication path 7 in the air communication section. The other branch is connected to a subtank 41, and the ink in the inktank 5 is supplied to the subtank 41. The subtank 41 and a supply tube 2 communicate with each other via opening/closing valves 3. The subtank 41 also includes a liquid surface control member 10 made of a flexible member changeable in volume. The liquid surface control member 10 has the same arrangement as that described in the first embodiment with reference to FIG. 3.

The volume of the liquid surface control member 10 is changed when the subtank is not filled with the ink. If the volume is expanded, the ink in the inktank is brought into the subtank. If the volume is reduced, air in the subtank moves to the inktank. An ink supply operation from the inktank to the subtank is executed by repeating such a volume change. If the volume of the liquid surface control member 10 is changed when the subtank is filled with the ink, the ink moves between two tanks, executing an ink stirring operation.

A pair of metal needles 39 and 40 is provided in the subtank 41. A voltage value increases which is obtained when an electric current is sent if the height of an ink residual amount becomes lower than the lower end of the metal needle 39, making it possible to detect a near end of the ink in the subtank.

As described above, according to the ink supply subsystem according to this embodiment, even if the ink in the inktank 5 is consumed and runs out as shown in FIG. 8B, the ink in the subtank 41 can be used. This makes it possible to continue a printing operation. A detection unit for an ink residual amount using the pair of metal needles 39 and 40 is not provided in the inktank 5, but is provided only in the subtank 41. This is because it is found that the ink in the inktank 5 runs out at a point in time when an ink liquid surface in the subtank 41 is detected.

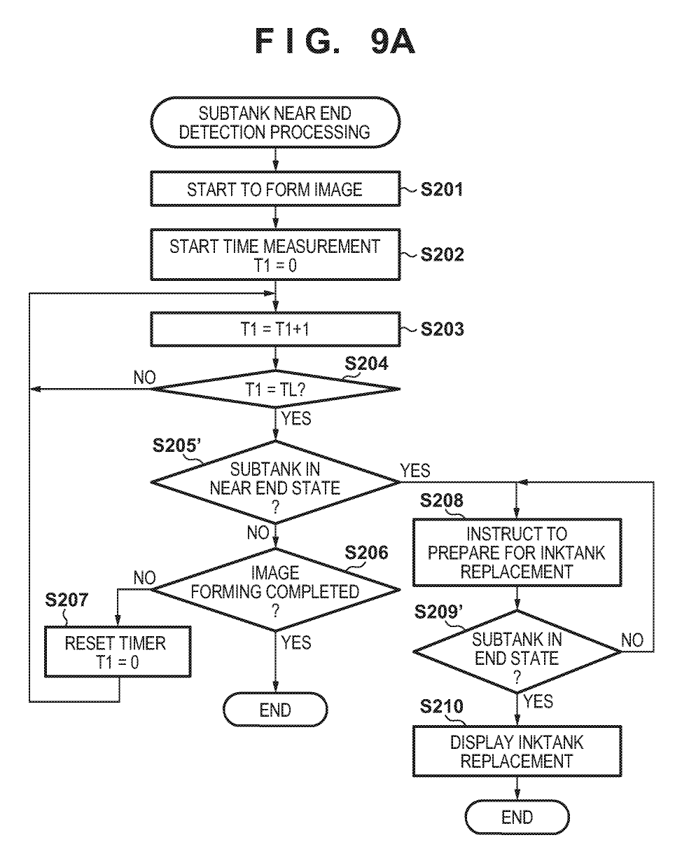

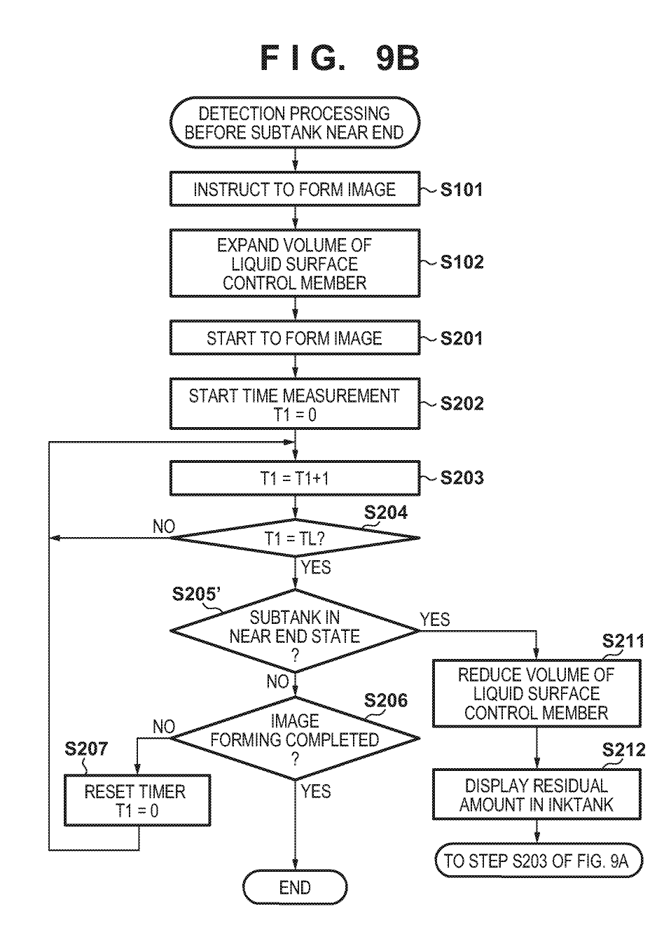

FIGS. 9A and 9B are flowcharts showing ink residual amount detection processing during image forming in the printing apparatus which includes the ink supply subsystem having the arrangement shown in FIGS. 8A and 8B.

FIG. 9A is the flowchart showing near end detection processing. FIG. 9B is the flowchart showing a process of detecting a state before a near end. Note that in the flowcharts of FIGS. 9A and 9B, the same processing steps that have already been described in the first embodiment with reference to FIGS. 4A and 4B are denoted by the same step reference numbers, and an explanation thereof will be omitted.

FIG. 5 is a view showing a situation in which the ink in the inktank 5 is consumed and set in a near end state.

As described already, if an ink amount is decreased by consuming the ink in the inktank 5, and the liquid surface becomes lower than vertical walls 31 around a hollow tube 9, it becomes difficult to send an electric current between a first hollow tube 8 and the second hollow tube 9. As a result, a measured voltage value increases, making it possible to detect the near end of the ink in the inktank 5. The near end detection processing in such a state will be described with reference to the flowchart of FIG. 9A.

Near End Detection Processing (FIG. 9A)

The process shown in this flowchart is basically the same as that described in FIG. 4A, but is different in step S209′ after step S208 and in that the process advances to step S205′ if it is determined in step S204 that T1=TL.

That is, it is checked in step S205′ whether the ink in the subtank 41 is in the near end state. If it is determined here that the ink in the subtank does not reach the near end state, the process advances to step S206. If it is determined, however, that the ink in the subtank reaches the near end state, the process advances to step S208.

In step S209′, an ink consumption amount (CSMP) is calculated by counting the number of ink droplets discharged from the printhead after the near end is detected. In addition, the ink consumption amount is compared with an acceptable ink consumption amount (to be referred to as an end amount (SEND) hereinafter) after the near end of the subtank 41 stored in a memory of the printing apparatus in advance. If the ink consumption amount falls within the end amount (CSMP<SEND) here, it is determined that the subtank 41 is not in the end state and image forming is allowed, and the process returns to step S208. If the ink consumption amount is equal to or larger than the end amount (CSMP≧SEND), it is determined that the ink in the subtank runs out, and the process advances to step S210.

As described above, also in this embodiment, it is possible, by making a determination of whether the subtank is set to the near end state at a predetermined timing (every three seconds here) during image forming, to notify a user of a preparation for inktank replacement at an appropriate timing.

The process of detecting a state before the ink in the subtank is set in the near end state will be described with reference to the flowchart of FIG. 9B.

Detection Processing Before Near End (FIG. 9B)

This processing is implemented by combining the volume change of the liquid surface control member 10, and near end detection by detecting the ink liquid surface in the subtank using the pair of metal needles 39 and 40 shown in FIGS. 8A and 8B.

The process shown in this flowchart is basically the same as that described in FIG. 4B, but is different in that the process advances to step S205′ if it is determined in step S204 that T1=TL, and the process advances to step S203 of FIG. 9A after step S212.

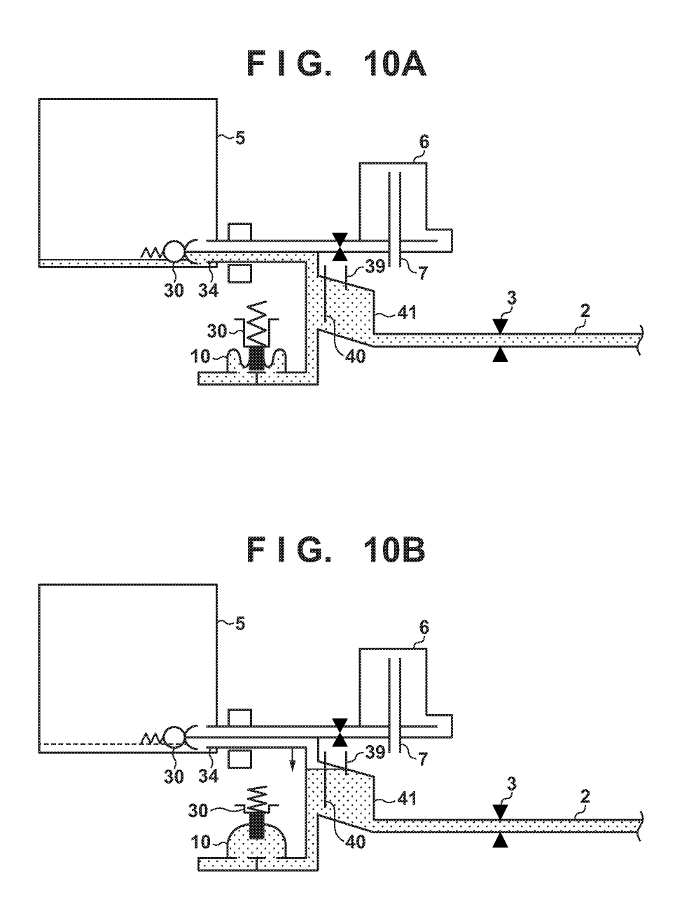

FIGS. 10A and 10B are views showing states of the volume changes of the liquid surface control member in the ink supply subsystem shown in FIGS. 8A and 8B. While FIG. 10A shows the state in which the volume of the liquid surface control member 10 is reduced, FIG. 10B shows the state in which the volume of the liquid surface control member 10 is expanded.

In the process shown in FIG. 9B, if the volume of the liquid surface control member 10 is expanded in step S102 as shown in FIG. 10B, the ink moves from the subtank 41 to the liquid surface control member 10 by that volume change amount, lowering the ink liquid surface in the subtank 41. This is shown in FIG. 10B as the ink liquid surface in the subtank 41 falls from a full state as indicated by a solid line.

It is checked in step S205′ whether the ink in the subtank 41 is in the near end state. If it is determined here that the ink in the subtank does not reach the near end state, the process advances to step S206. If it is determined, however, that the ink in the subtank reaches the near end state, the process advances to step S211.

In step S211, if the volume of the liquid surface control member 10 is reduced as shown in FIG. 10A, the ink returns to the subtank 41 by that volume change amount. As a result, a residual amount in the subtank 41 becomes an amount obtained by adding the volume of the liquid surface control member 10 to a near end capacity.

As described above, it is possible, by performing control obtained by combining near end detection and the volume change of the liquid surface control member 10, to detect an amount obtained by adding the volume change amount of the liquid surface control member 10 to a near end amount from a state in which the residual amount in the subtank cannot be grasped until the ink is used up to the near end amount.

For example, a case will be considered in which the volume of the subtank 41 is 12 cc, the near end amount is 10 cc, the volume change amount of the liquid surface control member 10 is 5 cc, and the volume of the hollow tube 34 between the inktank and the subtank is 2 cc. In this case, the ink residual amount can be detected, with the detection accuracy of near end detection, at two levels at which the ink residual amount in the subtank 41 falls below 10 cc and 15 cc. When the ink residual amount is 15 cc, the amount is larger by 1 cc than 14 cc obtained by adding the volume of the hollow tube of 2 cc to the volume of the subtank of 12 cc, resulting in 1 cc of ink remaining in the inktank 5. This makes it possible to display that the inktank 5 is immediately before becoming empty when the ink residual amount is 15 cc, and the subtank 41 is in the near end state when the ink residual amount is 10 cc.

It thus becomes possible to accurately notify the user of a preparation timing in replacing the inktank 5. It becomes also possible, by setting the volume change amount of the liquid surface control member 10 to 4 cc that is an amount obtained by adding the volume of the hollow tube 34 of 2 cc to the difference of 2 cc between the volume of the subtank 41 of 12 cc and the near end amount of 10 cc, to detect that the inktank 5 is in an empty state.

As described in the first embodiment, it is possible, by controlling the volume change amount of the liquid surface control member 10 at the plurality of levels, to accurately detect the ink residual amount up to the near end amount. Like the above-described example, if the volume change amount is controlled every 1 cc when the near end amount is 10 cc, and the volume change amount of the liquid surface control member 10 is 5 cc, it becomes possible to detect the residual amount in the subtank 41 every 1 cc from 14 cc to 10 cc.

Therefore, according to the embodiment described above, it is possible, by providing an arrangement in which the ink in the subtank is temporarily saved on an appropriate amount basis at a plurality of levels, to accurately sense the ink residual amount at the plurality of levels without providing a plurality of electrodes in the inktank.

Note that in the above-described two embodiments, the height of the ink liquid surface of the inktank or the subtank is lowered by changing the volume of the liquid surface control member 10 before the start of image forming. However, this may be performed immediately before a timing at which the near end of ink is determined.

Further, time measurement is started at the start of image forming in order to determine an execution timing in determining the near end. However, that time measurement may be started after the ink residual amount in the inktank reaches a predetermined amount equal to or more than the near end amount. For example, the ink consumption amount is calculated by storing, in advance, an ink capacity in the inktank 5 in the EEPROM 20 or the memory of the printing apparatus, and then counting the numbers of suction operations and discharge operations of ink from the printhead. Then, the ink residual amount in the inktank is calculated from the ink consumption amount and the ink capacity in the inktank, and time measurement may be started if the ink residual amount falls below the predetermined amount equal to or more than the near end amount.

Furthermore, although the near end detection processing is executed after sensing processing before the near end, these may be performed alternately.

Note that in this embodiment, the near end of ink is determined by sensing a voltage value obtained when a minute electric current (constant electric current) is sent between the first hollow tube 8 and the second hollow tube 9, and sensing energization via the ink from a change in the sensed voltage value. However, the present invention is not limited to this. For example, the near end of the ink may be determined from a change in a sensed value of an electric current which is sent when a constant voltage is applied between the first hollow tube 8 and the second hollow tube 9.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-080473, filed Apr. 13, 2016, which is hereby incorporated by reference herein in its entirety.

What is claimed is:

1. An inkjet printing apparatus comprising:
a printhead configured to print an image by discharging ink;
an inktank configured to contain the ink supplied to the printhead;
a reservoir capable of temporarily containing the ink supplied from the inktank;
a detection unit configured to perform a detection operation of detecting whether an ink amount in the inktank is more than a predetermined amount; and
a control unit configured to cause the detection unit to perform the detection operation in a first state in which the reservoir contains the ink supplied from the inktank.

2. The apparatus according to claim 1, wherein the control unit further causes the detection unit to perform the detection operation in a second state in which the reservoir does not contain the ink.

3. The apparatus according to claim 2, wherein the control unit causes the detection unit to perform the detection operation in the second state after moving the ink from the reservoir to the inktank if the ink amount in the inktank is less than the predetermined amount as a result of causing the detection unit to perform the detection operation in the first state.

4. The apparatus according to claim 1, wherein the reservoir is further configured to change a volume of the reservoir, and
the control unit moves the ink from the inktank to the reservoir by increasing the volume of the reservoir and moves the ink from the reservoir to the inktank by reducing the volume of the reservoir.

5. The apparatus according to claim 2, further comprising a display unit configured to display a message if the ink amount in the inktank is less than the predetermined amount in the first state and if the ink amount in the inktank is less than the predetermined amount in the second state.

6. The apparatus according to claim 5, wherein the first state includes a state in which the reservoir contains a first amount of ink and a state in which the reservoir contains a second amount of ink smaller than the first amount.

7. The apparatus according to claim 6, wherein the control unit causes the detection unit to perform the detection operation after returning the ink from the reservoir to the inktank so as to obtain a state in which the reservoir contains the second amount of ink if the ink amount in the inktank is less than the predetermined amount as a result of causing the detection unit to perform the detection operation in a state in which the reservoir contains the first amount of ink.

8. The apparatus according to claim 4, further comprising an ink channel configured to supply ink supplied form a bottom of the ink tank to the printhead,
wherein the ink from the inktank is supplied to the reservoir by a channel branched out from the ink channel, and
the control unit changes the volume of the reservoir during an image forming operation according to an image forming instruction from a host apparatus.

9. The apparatus according to claim 6, wherein the display unit displays a first message indicating that the ink amount is little at a point in time when the detection unit detects that the ink amount is less than the predetermined amount in a state in which the first amount of ink is moved to the reservoir and displays a second message to prompt a preparation for replacing the inktank at a point in time when it is determined that the detection unit detects that the ink amount is less than the predetermined amount in a state in which the first amount of ink is returned to the inktank.

10. The apparatus according to claim 6, wherein the control unit can change a volume of the reservoir at multi-level every third amount smaller than the first amount,
after moving the first amount of ink from the inktank to the reservoir, the control unit reduces the volume of the reservoir each time the detection unit detects that the ink amount is less than the predetermined amount and repeats, to a reduction limit of a volume change of the reservoir, control of returning the ink from the reservoir to the inktank every third amount, and
the display unit displays the ink amount each time the ink returns to the inktank by the third amount.

11. The apparatus according to claim 1, wherein a determination of whether the detection unit detects that the ink amount is less than the predetermined amount is made each time a predetermined time has elapsed.

12. The apparatus according to claim 1, wherein the reservoir is made of a flexible member and further comprising:
a spring configured to bias the flexible member in a direction that reduces a volume of the reservoir;
a lever configured to stretch and compress the spring; and
a driving source configured to operate the lever, and
wherein the control unit changes the volume by driving the driving source, and controlling stretch and compression of the spring via the lever.

13. The apparatus according to claim 10, further comprising:
a count unit configured to count a number of ink droplets discharged from the printhead from a point in time when it is determined that the ink amount is less than the predetermined amount in a state in which the first amount of ink is returned to the inktank; and
a comparison unit configured to compare an ink consumption amount calculated based on a count by the count unit with a predetermined acceptable ink consumption amount,
wherein if it is determined, by a comparison by the comparison unit, that the ink consumption amount exceeds the acceptable ink consumption amount, an image forming operation is stopped, and the display unit displays a message to prompt for inktank replacement.

14. The apparatus according to claim 1, wherein the detection unit detects whether the ink amount in the inktank is more than the predetermined amount by providing two electrodes at a bottom of the inktank, sending a constant electric current between the two electrodes or applying a constant voltage between the two electrodes, and measuring a resistance value between the two electrodes.

15. The apparatus according to claim 14, wherein each of the two electrodes is a hollow tube serving as an ink channel and made of a metal.

16. The apparatus according to claim 1, further comprising a subtank,
wherein the detection unit detects whether the ink amount in the inktank is more than the predetermined amount by providing two electrodes in the subtank, sending a constant electric current between the two electrodes or applying a constant voltage between the two electrodes, and measuring a resistance value between the two electrodes, and
the subtank is provided between the reservoir and an ink channel from the inktank to the printhead.

17. The apparatus according to claim 16, wherein the two electrodes are metal needles different in length provided in the subtank.

18. A method of detecting an ink amount in an inkjet printing apparatus which includes a printhead configured to print an image by discharging ink, and an inktank configured to contain the ink supplied to the printhead, the method comprising:
performing a detection operation of detecting whether the ink amount in the inktank is more than a predetermined amount in a first state in which a reservoir capable of temporarily containing the ink supplied from the inktank contains the ink supplied from the inktank.

19. The method according to claim 18, further comprising performing the detection operation in a second state in which the reservoir does not contain the ink.

20. The method according to claim 19, wherein if the ink amount in the inktank is less than the predetermined amount as a result of performing the detection operation in the first state, the detection operation is performed in the second state after moving the ink from the reservoir to the inktank.
